(19) United States
(12) Patent Application Publication
(10) Pub. No.: US 2024/0263654 A1
(43) Pub. Date: Aug. 8, 2024

(54) QUICKCHANGE PLUS

(71) Applicant: SOMIC VERPACKUNGSMASCHINEN GMBH & CO. KG, Amerang (DE)

(72) Inventors: Brigitte Stockenreiter, Eiselfing (DE); Christoph Kögel, Prutting (DE)

(21) Appl. No.: 18/428,785

(22) Filed: Jan. 31, 2024

(30) Foreign Application Priority Data
Feb. 2, 2023 (EP) 23154626.8

(51) Int. Cl. F16B 2/06

(52) U.S. Cl. CPC F16B 2/06

(57) ABSTRACT

A connection device with an active connecting part and a passive connecting part. The active connecting part comprises a coupling element projecting from a contact surface. At least one male connecting element is provided on one of the connecting parts and at least one associated female connecting element is provided on the other of the connecting parts. The at least one male connecting element and the at least one associated female connecting element are arranged such that, when the two connecting parts approach each other, they can be coupled to each other in a media-conducting manner. At least one connecting part has a holder which is arranged on a base element of the respective connecting part to be displaceable by a predetermined distance in the connection direction, and to which at least one male connecting element and/or at least one female connecting element is attached.

### CROSS REFERENCE TO RELATED APPLICATIONS

This application claims priority to European Patent Application No. 23154626.8, filed in Europe on Feb. 2, 2023, the entire contents of which are hereby incorporated herein by this reference.

### DESCRIPTION

The invention relates to a connection device having an active connecting part and a passive connecting part, wherein the active connecting part comprises a contact surface and a coupling element projecting from the contact surface, wherein the coupling element can be displaced relative to the contact surface between an extended release position and a retracted connection position by means of an actuating mechanism in a connection direction extending substantially orthogonally to the contact surface, and wherein the passive connecting part comprises a mating contact surface intended to cooperate with the contact surface, wherein the mating contact surface comprises a lateral recess which is designed and intended to receive the coupling element when the passive connecting part and the active connecting part approach each other in an approach direction which is substantially orthogonal to the connection direction.

Such connection devices are used by the applicant under the designation “QuickChange” for the mechanical connection of machine components. However, the coupling of media-conducting lines, for example power lines, data lines, compressed-air lines, vacuum lines, i.e. in which the pressure is lower than the ambient pressure, hydraulic lines and similar lines, must be carried out separately. This involves a great amount of work as well as the risk of operating errors.

The object of the invention is to further develop the known connection device in such a way that it can be used not only for mechanical connection, but also for connecting media lines at the same time.

In accordance with the invention, this object is achieved by a connection device of the type mentioned at the beginning, in which at least one male connecting element is provided on one of the connecting parts, the active connecting part or the passive connecting part, and at least one associated female connecting element is provided on the other of the connecting parts, the passive connecting part or the active connecting part, wherein the at least one male connecting element and the at least one associated female connecting element are arranged in such a way that they can be coupled to one another in a media-conducting manner when the two connecting parts approach each other in the approach direction, and that the active connecting part and/or the passive connecting part has a holder which is arranged on a base element of the respective connecting part so as to be displaceable by a predetermined distance in the connection direction, and wherein at least one male connecting element and/or at least one female connecting element is attached to the holder.

According to the invention, the media-conducting coupling of the at least one male connecting element and the associated female connecting element, i.e. the coupling of at least two media-conducting line sections (hereinafter also referred to simply as “media line”), which are set up to guide the same medium, takes place as the two connecting parts approach each other in the approach direction. This provides a coupling path that is greater than the connection path that the two connecting parts travel as a result of the actuation of the actuating mechanism in the connection direction in order to bring the contact surface and the mating contact surface into contact with each other. This in turn enables the use of conventional commercially available male-connector/female-connector combinations, which simplifies the design and reduces the production costs by eliminating the need to design and provide separate male-connector/female-connector combinations.

In addition, the solution according to the invention means that only one coupling process is required for each functional unit to be replaced. On the one hand, this reduces the time required to replace the functional unit and, on the other hand, eliminates the risk of confusion between the coupling points designated for the functional unit in question and the coupling points designated for other functional units.

In principle, the use of a motor-operable actuating mechanism is also conceivable. However, it is preferable for the actuating mechanism to be a manually operable actuating mechanism, particularly with regard to the production costs. The manually operable actuating mechanism can, for example, comprise an eccentric lever mechanism such as that used in the applicant's known “QuickChange” connection device.

In order to be able to avoid mechanical clearance, it can be provided that the coupling element is preloaded into the release position by means of a spring unit.

It shall be added here that the connection path, i.e. the distance traveled by the coupling element between the release position and the connection position, in the applicant's “QuickChange” connection device is approximately 2 mm in length, whereas the coupling path of a male connecting element and its associated female connecting element to produce the media-conducting coupling can be up to 10 mm in length.

In order to reduce or even completely eliminate the risk of damage to the male-connector/female-connector combinations when they are being coupled, it is proposed in a further development of the invention that at least one guide pin is provided on one of the connecting parts, the active connecting part or the passive connecting part, and at least one associated guide hole is provided on the other of the connecting parts, the passive connecting part or the active connecting part, wherein the at least one guide pin projects further from the one connecting part than the or the longest male connecting element. In this way, it can be ensured that the two connecting parts are pre-aligned to each other by the engagement of the guide pin(s) in the associated guide hole(s) before the first male connecting element engages with its associated female connecting element.

It shall also be added that the holder according to the invention can be arranged in on the base element of the associated connecting part in various ways so as to be displaceable. For example, a linear guide can be provided by means of which the holder is mounted on the base element in a displaceable manner. Additionally or alternatively, an elastically deformable material can be provided between the holder and the base element, which is compressed during the connection of the two connecting parts and decompresses again when the connection is released. As an alternative to the use of an elastically deformable material, the arrangement of compression springs and/or tension springs between the holder and the base element can also be considered.

In a further development of the invention, it is proposed that at least one media line is a non-fluidic media line, for example a power supply line and/or a signal transmission line. The signal transmission line can be designed both as an electrical signal transmission line and as an optical signal transmission line. For this purpose, at least one male connecting element and at least one associated female connecting element can be designed to produce a coupling for conducting a non-fluidic medium in a coupled state, for example in order to supply power and/or to transmit an electrical signal and/or an optical signal.

Additionally or alternatively, it can be provided that at least one media line is a fluid media line, for example a compressed-air line and/or a vacuum line and/or a hydraulic line. For this purpose, at least one male connecting element and at least one associated female connecting element can be designed to produce a fluid-conducting coupling in a coupled state, for example to conduct compressed air and/or a fluid under vacuum and/or a hydraulic fluid.

For compressed-air and/or vacuum lines, for example, at least one female connecting element can comprise a sealing ring. To produce the media-conducting coupling, for example, an annular surface or an annular projection of the associated male connecting element can be pressed against the sealing ring in an axial or radial direction to form a seal. This type of media-conducting coupling only requires such a short coupling path that, in a further development of the invention, it could in principle also be considered to bring about this media-conducting coupling only in the course of the connecting movement of the two connecting parts.

With regard to the production costs, however, it is preferable if the at least one male connecting element and the at least one associated female connecting element are part of a commercially available industrial male connector, one half of which is integrated into the active connecting part and the other half of which is integrated into the passive connecting part.

The invention will be described in more detail below by way of example and with reference to the attached drawings, in which:

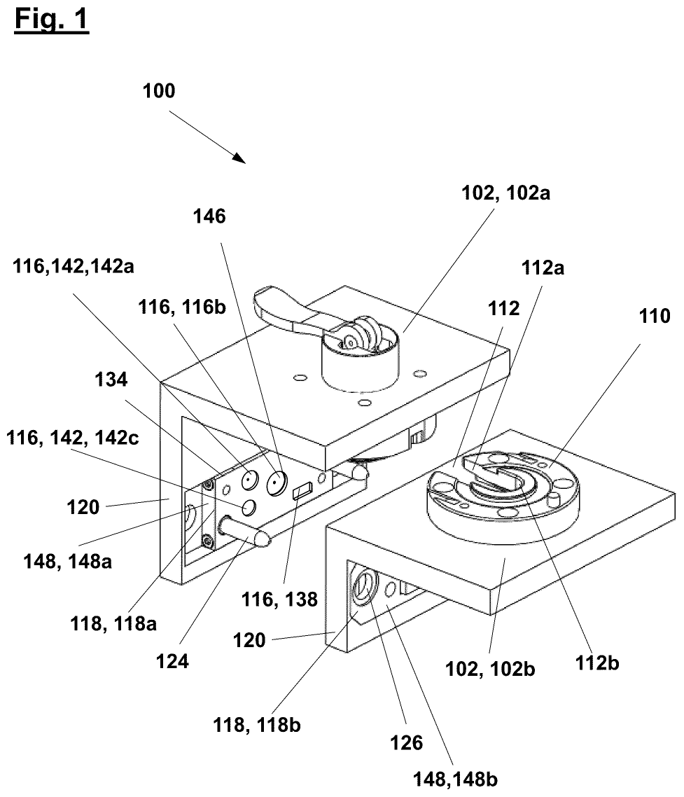

FIG. 1 shows a perspective view of a connection device in the release position, according to certain embodiments of the invention;

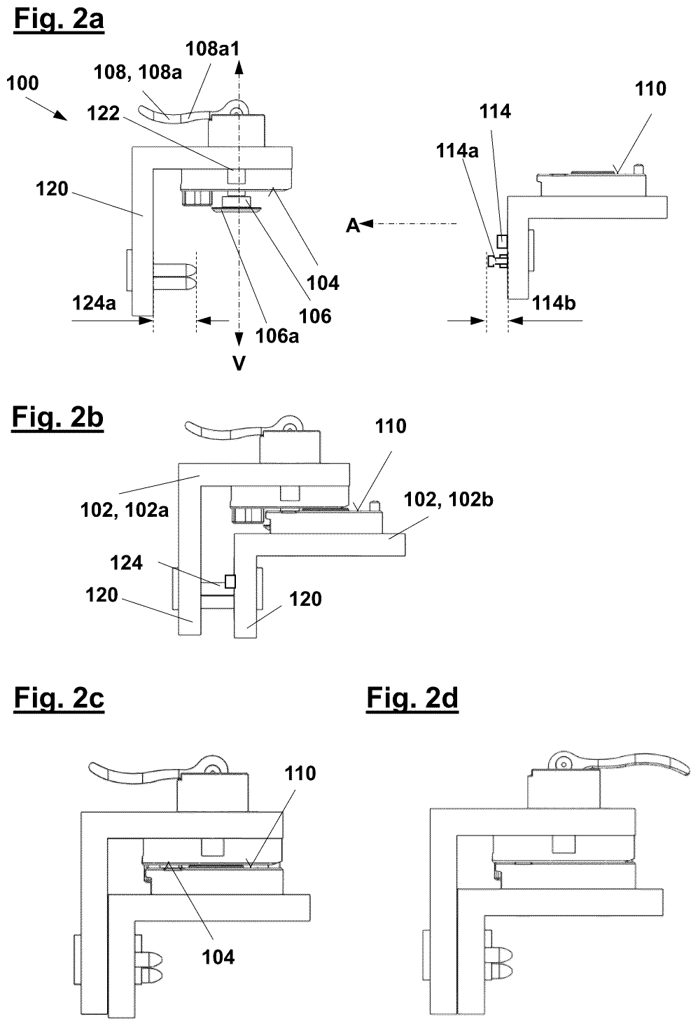

FIG. 2a, FIG. 2b, FIG. 2c and FIG. 2d show schematic side views of various positions which the active and passive connecting parts assume relative to one another in the course of their connection, according to certain embodiments of the invention; and

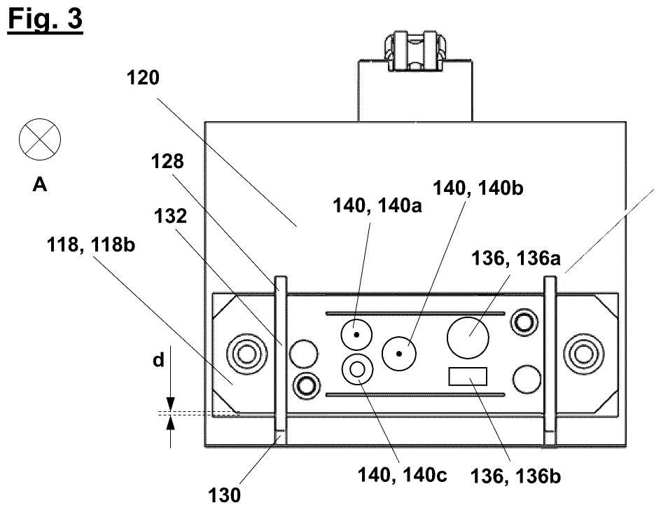

FIG. 3 shows a view in the approach direction of the passive connecting part, according to certain embodiments of the invention. In FIG. 1, a connection device according to the invention is generally designated 100.

The connection device 100 comprises two connecting parts 102, namely an active connecting part 102a and a passive connecting part 102b.

As shown, for example, in FIG. 2a, the active connecting part 102a comprises a contact surface 104 and a coupling element 106 projecting from the contact surface. The coupling element 106 can be displaced relative to the contact surface 104 between an extended release position (FIG. 2a) and a retracted connection position (FIG. 2d) by means of an actuating mechanism 108 in a connection direction V which is substantially orthogonal to the contact surface 104.

The passive connecting part 102b comprises a mating contact surface 110, which is designed and intended to cooperate with the contact surface 104 of the active connecting part 102a. The mating contact surface 110 comprises a lateral recess 112 (see FIG. 1), which is designed and intended to receive the coupling element 106 when the passive connecting part 102b and the active connecting part 102a approach each other in an approach direction A (see FIG. 2a) which is substantially orthogonal to the connection direction V.

Both connecting parts 102 have at least one coupling point. At least one male connecting element 114 is provided on one of the connecting parts 102, according to FIG. 2a the passive connecting part 102b, while at least one associated female connecting element 116 is provided on the other of the connecting parts 102, here (see FIG. 1) the active connecting part 102a. The at least one male connecting element 114 and the at least one associated female connecting element 116 are arranged in such a way that they can be coupled to each other in a media-conducting manner when the two connecting parts 102 approach each other in the approach direction A. In other words, at least one male connecting element 114 and at least one female connecting element 116 are assigned to one another and are arranged to engage with one another and produce a media-conducting coupling. In particular, the coupling of the male connecting element 114 and the female connecting element 116 can be used to couple two (not shown) media line sections together. It should already be pointed out here that a combination of at least one male connecting element 114 and at least one associated female connecting element 116 can be conventional commercially available male-connector/female-connector combinations.

According to FIG. 1, at least one connecting part 102 has a holder 118. Furthermore, each connecting part 102 has a base element 120. At least one male connecting element 114 and/or one female connecting element 116 is attached to the holder 118. In the embodiment according to the invention, both the active connecting part 102a has a holder 118a and the passive connecting part 102b has a holder 118b. The holder 118a of the active connecting part 102a is attached to the associated base element 120 in such a way that the holder 118a can be displaced in the connection direction V by a predetermined distance d (see FIG. 3).

In principle, it is conceivable that the holders 118 have both male connecting elements 114 and female connecting elements 116. However, the holders 118 can also have either only male connecting elements 114 or only female connecting elements 116. In the embodiment shown, the holder 118a only has female connecting elements 116, while the holder 118b only has male connecting elements 114.

The active connecting part 102a having the actuating mechanism 108 is usually permanently connected to a machine component. To prepare for coupling with the passive connecting part 102b, the actuating mechanism 108 is brought into a release position (see FIG. 2a). In the embodiment shown, the actuating mechanism 108 is a manually operable actuating mechanism, in particular an eccentric lever mechanism 108a, the lever 108a1 of which is pivoted into the release position. This causes the coupling element 106 in FIG. 2a to move downwards. This movement can be supported by biasing a spring unit 122 in order to avoid mechanical clearance.

In order to couple the active connecting part 102a and the passive connecting part 102b, the passive connecting part 102b is moved towards the active connecting part 102a in the approach direction A (see FIG. 2a) until the lateral recess 112 of the passive connecting part 102b receives the coupling element 106 of the active connecting part 102a (see FIG. 2b). Due to the reception of the coupling element 106 by the lateral recess 112, the relative movement between the two connecting parts 102 is guided in the approach direction A. In addition, an engagement behind a plate 106a of the coupling element 106 by a projection 112a of the lateral recess 112 can prevent a movement of the two connecting parts 102 relative to each other in the connection direction V during the approach in the approach direction A.

As a result of the approach of the two connecting parts 102, the at least one male connecting element 114 and the associated female connecting element 116 also approach each other in the approach direction A. In order to avoid damage to the male connecting element 114 and/or the female connecting element 116, at least one guide pin 124 is arranged on one of the connecting parts 102, in the embodiment shown on the active connecting part 102a, while the respective other of the connecting parts 102, in this case the passive connecting part 102b, has at least one associated guide hole 126. At least one guide pin 124 is longer than the longest male connecting element 114a. In other words, the extension 124a of the guide pin 124 in approach direction A is greater than an extension 114b of each of the male connecting elements 114 in approach direction A.

Due to this structural design, the guide pins 124 engage with the respective associated guide holes 126 in approach direction A first, before the male connecting elements 114 and the female connecting elements 116 do so. The further approach movement of the two connecting parts 102 in the approach direction A is thus guided not only by the interaction of the lateral recess 112 and the coupling element 106, but also by the interaction of the guide pins 124 with the associated guide hole 126. In particular, the interaction of guide pin 124 and guide hole 126 prevents a relative movement in the connection direction V between the at least one male connecting element 114 and the at least one female connecting element 116. According to the present embodiment, the guide pins 124 are attached to the holder 118.

After guide pins 124 and guide holes 126 have engaged with each other, the active connecting part 102a and the passive connecting part 102b are moved further towards each other in the approach direction A until the at least one male connecting element 114 and the at least one female connecting element 116 are coupled to each other (FIG. 2c). In this state, the coupling element 106 also rests against a stop 112b of the lateral recess 112, so that further movement of the coupling element 106 and thus also movement between the active connecting part 102a and the passive connecting part 102b in the approach direction A is prevented. However, the contact surface 104 and the mating contact surface 110 are still spaced apart.

In order to prevent disconnection of the at least one male connecting element 114 and the at least one associated female connecting element 116, the actuating mechanism 108 is now actuated. In particular, the lever 108a1 of the eccentric lever mechanism 108a is pivoted from the left position shown in FIG. 2c to the right position shown in FIG. 2d. As a result, the coupling element 106 is displaced in the connection direction V from the extended release position, if necessary by overcoming the spring force exerted by the spring unit 122, into the retracted connection position (see FIG. 2d). This causes the contact surface 104 of the active connecting part 102a and the mating contact surface 110 of the passive connecting part 102b to come into contact and engage with each other in the connection direction V.

Furthermore, the actuation of the actuating mechanism 108 effects a displacement of the holder 118a of the active connecting part and/or the holder 118b of the passive connecting part by a predetermined distance d in the connection direction V. A linear guide 128 can be provided in order to guide this displacement movement. For this purpose, the base element 120 has a linear guide hole 130, while a linear guide pin 132 is attached to the holder 118. By moving the linear guide pin 132 in the linear guide hole 130, the holder 118 can be displaced in the connection direction V by the predetermined distance d.

Alternatively or additionally, an elastically deformable material 134 may be provided between the holder 118 and the base element 120 (see FIG. 1). The elastically deformable material 134 is compressed in the connection direction V during the connection of the two connecting parts 102 and decompressed again when the connection is released.

In addition, at least one media line (not shown) can be a non-fluidic media line. This can be, for example, a power supply line and/or a signal transmission line. The signal transmission line can be designed both as an electrical signal transmission line and as an optical signal transmission line. Accordingly, at least one non-fluidically conductive male connecting element 136 is provided on one connecting part 102, which is set up for coupling non-fluidic media lines. The other connecting part 102 has at least one associated non-fluidically conductive female connecting element 138. FIG. 3 shows an example of a power-supply male connecting element 136a and a signal-transmission male connecting element 136b.

Alternatively or additionally, at least one media line (not shown) can be a fluidic media line. Accordingly, one connecting part 102 has at least one fluid-conducting male connecting element 140 and the other connecting part 102 has at least one associated fluid-conducting socket element 142. A compressed-air male connecting element 140a and a compressed-air female connecting element 142a, a vacuum male connecting element 140b and a hydraulic male connecting element 140c are shown as examples in FIG. 3.

In order to connect compressed-air and/or vacuum lines, a female connecting element 116b can comprise a sealing ring 146. In order to produce the media-conducting coupling, an annular surface or an annular projection of the associated male connecting element can be pressed against the sealing ring 146 in an axial or radial direction to form a seal, for example.

It should also be added at this point that at least one male connecting element 114 and at least one associated female connecting element 116 can be part of a commercially available industrial male connector 148. One half 148a of the industrial male connector 148 can be integrated into the active connecting part 102a and the other half 148b of the industrial male connector 146 can be integrated into the passive connecting part 102b. For example, the holder 118a of the active connecting part 102a may comprise one half 148a of the industrial male connector 148 and/or the holder 118b of the passive connection part 102b may comprise the other half 148b of the industrial male connector 148.

1. A connection device comprising:
an active connecting part; comprising a contact surface and a coupling element projecting from the contact surface, wherein the coupling element can be displaced relative to the contact surface between an extended release position and a retracted connection position by means of an actuating mechanism in a connection direction extending substantially orthogonally to the contact surface;
a passive connecting part comprising a mating contact surface intended to cooperate with the contact surface, wherein the mating contact surface comprises a lateral recess configured to receive the coupling element when the passive connecting part and the active connecting part approach each other in an approach direction which is substantially orthogonal to the connection direction;
wherein at least one male connecting element is provided on one of the active connecting part or the passive connecting part, and at least one associated female connecting element is provided on the other of the active connecting part or the passive connecting part;
wherein the at least one male connecting element and the at least one associated female connecting element are arranged in such a way that they can be coupled to one another in a media-conducting manner in the approach direction when the active connecting part and the passive connecting part approach each other;
wherein at least one of the active connecting part or the passive connecting part comprises a base element and a holder arranged on the base element so as to be displaceable in the connection direction; and
wherein the at least one male connecting element or the at least one associated female connecting element is attached to the holder.

2. The connection device according to claim 1, wherein the actuating mechanism is a manually operable actuating mechanism.

3. The connection device according to claim 1, wherein the coupling element is biased into the release position by means of a spring unit.

4. The connection device according to claim 1, wherein at least one guide pin is provided on the active connecting part or the passive connecting part, and at least one associated guide hole is provided on the other of the passive connecting part or the active connecting part, wherein the at least one guide pin projects further from the one connecting part than the or the longest male connecting element.

5. The connection device according to claim 1, wherein the at least one male connecting element and the at least one female connecting element are non-fluidically conductive; and
wherein coupling the at least one male connecting element and the at least one associated female connecting element forms a non-fluidic media line.

6. The connection device according to claim 5, wherein the non-fluidic media line comprises a power supply line.

7. The connection device according to claim 5, wherein the non-fluidic media line comprises a signal transmission line.

8. The connection device according to claim 1, wherein the at least one male connecting element and the at least one female connecting element are fluid conducting; and
wherein coupling the at least one male connecting element and the at least one associated female connecting element forms a fluidic media line.

9. The connection device according to claim 8, wherein the fluidic media line comprises a compressed-air line.

10. The connection device according to claim 8, wherein the fluidic media line comprises a vacuum line.

11. The connection device according to claim 8, wherein the fluidic media line comprises a hydraulic line.

12. The connection device according to claim 8, wherein the at least one female connecting element comprises a sealing ring.

13. The connection device according to claim 1, wherein the at least one male connecting element and the at least one associated female connecting element are part of a commercially available industrial male connector, one half of which is integrated into the active connecting part and the other half of which is integrated into the passive connecting part.
